(19) United States
(12) Patent Application Publication
(10) Pub. No.: US 2006/0047567 A1
(43) Pub. Date: Mar. 2, 2006

(54) Method and installation for pay parking management

(76) Inventor: Damien Mandy, Fontain (FR)

Correspondence Address: SOFER & HAROUN LLP., 317 MADISON AVENUE, SUITE 910, NEW YORK, NY, 10017, US

(21) Appl. No.: 10/530,248

(22) PCT Filed: Jul. 18, 2003
(86) PCT No.: PCT/EP03/07868

§ 371 Date: Sep. 13, 2005

(30) Foreign Application Priority Data
Oct. 9, 2002 (FR) 02/12549

(51) Int. Cl. G07B 15/00

(52) U.S. Cl. 705/13

(57) ABSTRACT

The invention concerns an installation for managing a pay parking facility for vehicles comprising a plurality of vehicle immobilizing devices (1) for immobilizing contravening vehicles, and wherein an unlocking code (8) is delivered to the user (0) after payment of the amount corresponding to the unlocking of the vehicle immobilizing device. Upon a request for unlocking from the user (0), the parking terminal (2) is adapted to set up a session corresponding to the unlocking of the vehicle immobilizing device with the payment means (3), to communicate to the server (4) of the identifier of the immobilizing device to be unlocked after the payment session has been validated while the server (4) is adapted to receive the identifier (7) thus input and to deliver in response the unlocking code (8) associated with the destination of the terminal to unlock the immobilizing device in question.

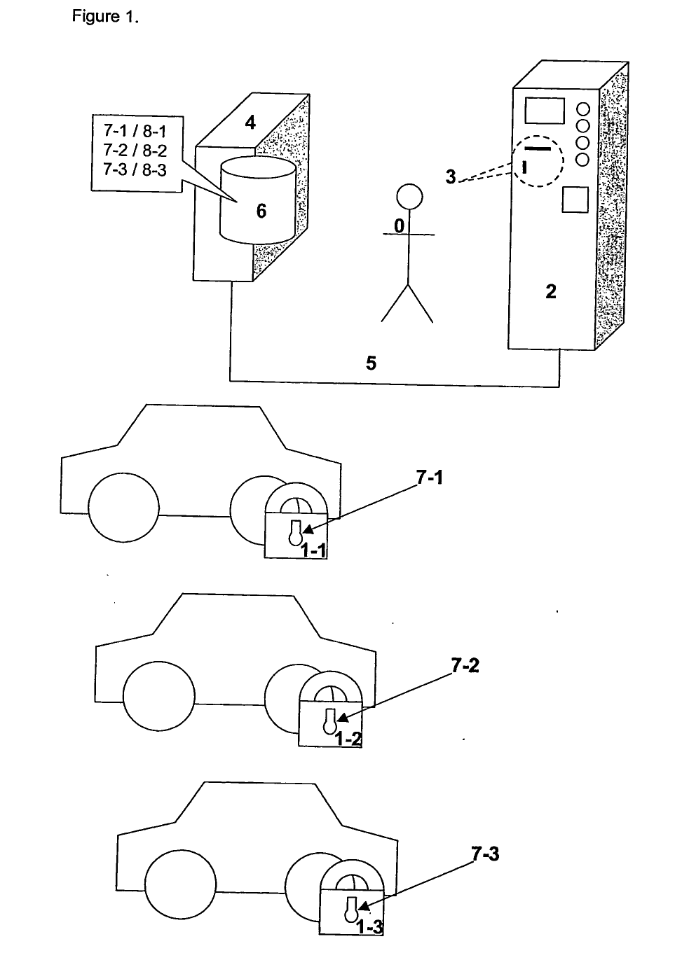

The present invention relates to chargeable parking where immobilizing devices immobilize defaulting vehicles and a release code is supplied to a user after payment of the corresponding fine to enable him to release the immobilizing device concerned.

It finds a general application in managing chargeable parking of vehicles, and more particularly in the field of car parks with numbered spaces.

Devices for immobilizing defaulting vehicles are known in the art and are known as clamps, vehicle immobilizers and tyre locks.

This kind of immobilizing device is generally released by inserting a key.

This key may be a physical key or a logical key (a secret code). In the latter case, the system is unlocked by entering a release code.

This code can be supplied to the user after paying the amount corresponding to the offence.

In practice, the release code is supplied to the user by telephone in response to supplying a bank card number for the account from which the amount of the fine is debited.

The above kind of method of managing chargeable parking is not totally satisfactory in terms of secure payment, in particular because a voice call giving the bank card number to a server may be fraudulently intercepted.

The present invention solves this problem.

It relates to a method of managing chargeable parking of vehicles, of the type using a plurality of vehicle immobilizing devices to immobilize defaulting vehicles and wherein a release code is delivered to the user after payment of the corresponding fine.

According to a general definition of the invention the method comprises the following steps:
a) providing at least one parking terminal equipped with payment means,
b) providing a server comprising a database connected to the parking terminal and containing a list of pairs of data items each formed of an identifier assigned to an immobilizing device and an associated release code,
c) in the event of a release request from a user, entering the identifier of said immobilizing device at said parking terminal,
d) at the parking terminal, setting up a session for payment of the amount corresponding to releasing the vehicle immobilizing device by means of the payment means, and communicating the identifier entered in this way to the server after validation of the payment session,
e) at the server, receiving the identifier entered in this way and in response delivering the associated release code to the terminal, and
f) at the terminal, receiving the release code delivered in this way to supply it to the user.

Thus the method of the invention automates the releasing of immobilizing devices with no voice call to a server, so that payment is secure.

The present invention also provides an installation for managing chargeable parking of vehicles, of the type comprising a plurality of vehicle immobilizing devices for immobilizing defaulting vehicles, and wherein a release code is delivered to the user after payment of an amount corresponding to releasing the vehicle immobilizing device.

According to an important feature of the invention the installation further comprises:
a parking terminal comprising payment means, and
a server comprising a database connected to the parking terminal and containing a list of pairs of data items each formed of an identifier assigned to an immobilizing device and an associated release code, and in the event of a release request from a user, the parking terminal is adapted to set up a session for payment of the amount corresponding to releasing the vehicle immobilizing device by means of said payment means and to communicate to the server the identifier of the immobilizing device to be released after validation of the payment session, while the server is adapted to receive the identifier entered in this way and to deliver in response thereto the associated release code to the terminal, in order to release the immobilizing device concerned.

Other features and advantages of the invention will become apparent in the light of the following detailed description and the drawings, the single FIGURE of which is a diagram of management of chargeable parking in accordance with the invention.

Referring to the single FIGURE, chargeable parking in accordance with the invention is implemented in a car park with numbered spaces, for example.

Three defaulting vehicles are immobilized by means of respective immobilizing devices 1-1, 1-2 and 1-3, for example.

As a general rule, each immobilizing device is assigned an identifier 7, for example an identifier 7-1 for the device 1-1, an identifier 7-2 for the device 1-2, and an identifier 7-3 for the device 1-3.

The identifier is a number on the immobilizing device, for example.

To release his vehicle, the user 0 goes to a parking terminal 2 equipped with payment means 3.

The payment means 3 can be for payment by means of coins, bank cards, electronic wallets and the like.

The payment means 3 can equally set up a payment session during which a call is set up between the user's mobile telephone and the terminal, which is also equipped with a transceiver and an antenna for setting up this kind of call.

The terminal 2 is equipped with a man-machine interface that may comprise a keypad and a display screen.

The terminal 2 is connected to a server 4 by a link 5.

The server 4 comprises a database 6.

The database 6 contains a list of pairs of items, each pair comprising an identifier 7 and a release code 8.

For example, the identifier 7-1 is coupled to the release code 8-1.

In the event of a release request by the user 0, said user enters on the terminal 2 the identifier 7-1 of the immobilizing device 1-1 that is immobilizing his vehicle.

The parking terminal 2 can set up a session for payment of the corresponding fine by means of the payment means 3.

The user 0 chooses the bank card mode of payment, for example.

After validation of the payment, the identifier 7-1 entered at the terminal is communicated to the server via the link 5.

The server 4 receives the identifier 1-1 and responds by looking up the release code in the database, here the code 8-1.

The code 8-1 found in this way is returned to the terminal, which supplies it to the user to enable him to release his vehicle.

In practice, a plurality of terminals may connect to the server, which then serves as a database able to provide data specific to each immobilizing device.

The terminal 2 may be equipped with a unit for delivering a payment receipt providing proof of payment and on which additional information may be indicated.

The identifier 7 may be entered at the terminal by means of a keypad, by reading a bar code, by reading a badge of the contact or contactless type, by short-range communication between a communication device (mobile telephone) and the compatible transceiver equipping the terminal.

The release code 8 may be printed on a receipt.

Alternatively, the release code is stored on an appropriate medium from the group comprising cards and tickets of the contact or contactless type and can be read by the immobilizing device concerned.

Alternatively, in the event of payment by mobile telephone of the amount corresponding to releasing the vehicle immobilizing device, the release code may be returned to the same telephone in the form of a voice or visual (SMS) message.

Where parking places are numbered, the identifier of the immobilizing device may be linked to the number of the space in which the vehicle is parked. In this case, the user enters the space number on the corresponding terminal to execute a transaction in the amount corresponding to releasing the vehicle immobilizing device.

In this mode, in respect of spaces managed by the same terminal, the server may consist of the space management terminal.

Alternatively, the identifier of the immobilizing device may be linked to a number such as the registration number of the vehicle. In this case, when the user subscribing to the mobile telephone parking service calls the server to carry out a transaction, the server can automatically prompt payment for releasing the immobilizing device corresponding to his vehicle.

1. A method of managing chargeable parking of vehicles, of the type using a plurality of vehicle immobilizing devices to immobilize defaulting vehicles, wherein a release code is delivered to the user after payment of the corresponding fine, said method comprising the following steps:
a) providing at least one parking terminal equipped with payment means;
b) providing a server comprising a database connected to the parking terminal and containing a list of pairs of data items each formed of an identifier assigned to an immobilizing device and an associated release code;
c) in the event of a release request from a user, entering the identifier of said immobilizing device at said parking terminal;
d) at the parking terminal, setting up a session for payment of the amount corresponding to releasing the vehicle immobilizing device by means of the payment means, and communicating the identifier entered in this way to the server after validation of the payment session;
e) at the server, receiving the identifier entered in this way and in response delivering the associated release code to the terminal; and
f) at the terminal, receiving the release code delivered in this way to supply it to the user.

2. Installation for managing chargeable parking of vehicles, of the type comprising a plurality of vehicle immobilizing devices for immobilizing vehicles defaulting, and wherein a release code is delivered to the user after payment of an amount corresponding to releasing the vehicle immobilizing device, said installation comprising:
a parking terminal having payment means, and
a server having a database connected to the parking terminal and containing a list of pairs of data items each formed of an identifier assigned to an immobilizing device and an associated release code, and in that in the event of a release request from a user, the parking terminal is adapted to set up a session for payment of the amount corresponding to releasing the vehicle immobilizing device by means of said payment means and to communicate to the server the identifier of the immobilizing device to be released after validation of the payment session, while the server is adapted to receive the identifier entered in this way and to deliver in response thereto the associated release code to the terminal, in order to release the immobilizing device concerned.

3. Parking terminal belonging to the installation according to claim 1, further comprising payment means adapted to process payment means from the group comprising coins, a bank card, an electronic wallet or the like, a mobile telephone.

4. Terminal according to claim 3, further comprising a means for entering an identifier from the group comprising a keypad and/or a screen, a bar code reader, a ticket reader of the contact or contactless type, a transceiver adapted to set up a call to a mobile telephone or the like.

5. Terminal according to claim 3, further comprising a means adapted to deliver the release code on a printed receipt or stored on a ticket of the contact or contactless type that the immobilizing device concerned is able to read.
